(19) United States
(12) Patent Application Publication
(10) Pub. No.: US 2008/0097853 A1
(43) Pub. Date: Apr. 24, 2008

(54) System and Method for Supplying Integrated Mileage Service

(76) Inventors: IN HO KIM, Yeongdeungpo-gu (KR); Jae Young Lee, Seocho-gu (KR)

Correspondence Address: SALIWANCHIK LLOYD & SALIWANCHIK;A PROFESSIONAL ASSOCIATION, PO BOX 142950, GAINESVILLE, FL, 32614-2950, US

(21) Appl. No.: 11/877,901

(22) Filed: Oct. 24, 2007

(30) Foreign Application Priority Data
Oct. 24, 2006 (KR) 10-2006-1013652
Nov. 20, 2006 (KR) 10-2006-0114270
Dec. 29, 2006 (KR) 10-2006-0137720
Jan. 31, 2007 (KR) 10-2007-0010297
Jan. 31, 2007 (KR) 10-2007-0010298

(51) Int. Cl. G06Q 30/00; G06F 17/30; G06F 17/40

(52) U.S. Cl. 705/14

(57) ABSTRACT

Provided are a system and method for supplying an integrated mileage service. The system includes: a member store point of sale (POS) terminal for receiving mileage accumulation or spending request data including a card number of an integrated mileage card into which a plurality of membership cards are integrated, a payment amount, and member store identification (ID) information when a customer purchases a commodity; a mileage provider server for receiving the mileage accumulation or spending request data from the member store POS terminal and accumulating or spending mileage points corresponding to the payment amount based on customer mileage information previously stored in a mileage database (DB) to generate the corresponding result data; an integrated mileage service server for receiving itemized statements of accumulation or use of mileage points and a current mileage balance of the customer, which are batch-processed at predetermined time intervals, from respective mileage provider servers, storing the itemized statements and the current mileage balance in an integrated mileage DB, and integratedly managing the stored itemized statements and the current mileage balance to provide an integrated mileage inquiry service when a plurality of mileage provider servers are used. In this system, the customer can integratedly accumulate or spend mileage points of a plurality of affiliated mileage providers by use of a single integrated mileage card.

### CROSS-REFERENCE TO RELATED APPLICATIONS

The present application claims the benefit under 35 U.S.C. §119 of Korean Patent Application No. 10-2006-0103652, filed Oct. 24, 2006, Korean Patent Application No. 10-2006-0114270, filed Nov. 20, 2006, Korean Patent Application No. 10-2006-0137720, filed Dec. 29, 2006, and Korean Patent Application Nos. 10-2007-0010297 and 10-2007-0010298, filed Jan. 31, 2007, which are hereby incorporated by reference in their entirety.

### BACKGROUND

In general, a mileage service is a point service system, aimed at minimizing loss of customers and providing customers with incentive to purchase more and continue purchasing. It is also utilized for customer management based on a customer database (DB).

Currently, many corporations provide customers enrolled as members with mileage points calculated at a predetermined rate based on customer purchase amount, and give various rewards to customers that have reached a predetermined number of mileage points based on a reward point accumulation program.

That is, customers have to earn a predetermined number of mileage points or more in order to utilize them. However, since it is usually difficult to earn the predetermined number of mileage points or more, mileage points earned by most customers do not exceed the predetermined level and remain unused.

The mileage service may be classified as an integrated mileage service in which mileage points can be accumulated and spent at any member store, or as an independent mileage service in which mileage points can be accumulated and spent only at company-owned stores or chain stores.

When purchasing a commodity at a member store, a customer presents a card for accumulating mileage points along with a form of payment, such as a credit card, a department store card, or a prepayment card, which are widely used for conventional commercial transactions. Then, mileage points corresponding to a predetermined amount of money are accumulated in the accumulation card. Thus, when the accumulated mileage points come to a predetermined sum or more, the customer may select a desired prize or spend the mileage points like cash.

However, according to a conventional method for supplying mileage points using an accumulation card, it is quite inconvenient for purchasers to carry a great number of accumulation cards issued by respective member stores in order to obtain mileage points after paying for goods or services.

Also, carrying many accumulation cards has become even more inconvenient due to recent increase in the number of various membership cards, credit cards, and mileage point cards available to consumers.

Furthermore, it is troublesome for consumers to keep track of all their mileage points accumulated from different places using itemized accrual statements, etc.

In addition, since a corporation that provides a mileage service (especially, an independent mileage service) constructs and operates its mileage system independently, the corporation must additionally bear the cost of constructing the mileage system, personnel expenses incurred by employing system operators, all marketing expenses, and expenses for issuing mileage cards.

Moreover, in the conventional method of providing mileage service, only members that join a mileage provider can accumulate or spend mileage points at affiliated member stores. Therefore, many customers suffer much inconvenience since they must search for and visit only affiliated member stores in order to accumulate mileage points. Also, when customers purchase goods or services in member stores that they have not joined, they may suffer comparative losses.

### BRIEF SUMMARY

The present invention is directed to a system and method for supplying an integrated mileage service in which a customer can integratedly accumulate or spend mileage points of affiliated mileage providers using an integrated mileage card in order to promote the convenience of customers with mileage cards and reduce expenses incurred by issuing and managing mileage cards.

Also, the present invention is directed to a system and method for supplying an integrated mileage service in which after purchasing commodities at member stores affiliated with various mileage providers using an integrated mileage card, customers can periodically receive electronic mail (e-mail) services for informing them of integrated mileage information from an integrated mileage service server for integratedly managing information on accumulated mileage points, spent mileage points, and a current mileage balance.

Further, the present invention is directed to a system and method for supplying an integrated mileage service in which a plurality of mileage providers cooperate with one another so that a customer can spend mileage points, which are accumulated at member stores of a specific mileage provider that the customer has joined, even at member stores of other affiliated mileage providers.

According to an aspect of the invention, a system for supplying an integrated mileage service includes: a member store point of sale (POS) terminal for receiving mileage accumulation or spending request data including a card number of an integrated mileage card into which a plurality of membership cards are integrated, a payment amount, and member store identification (ID) information when a customer purchases a commodity; a mileage provider server for receiving the mileage accumulation or spending request data from the member store POS terminal and accumulating or spending mileage points corresponding to the payment amount based on customer mileage information previously stored in a mileage database (DB) to generate the corresponding result data; an integrated mileage service server for receiving itemized statements of accumulation or use of mileage points and a current mileage balance of the customer, which are batch-processed at predetermined time intervals, from respective mileage provider servers, storing the itemized statements and the current mileage balance in an integrated mileage DB, and integratedly managing the stored itemized statements and the current mileage balance to provide an integrated mileage inquiry service when a plurality of mileage provider servers are used.

According to another aspect of the invention, a method for supplying an integrated mileage service to gain membership using a system for supplying the integrated mileage service includes: connecting to an integrated mileage service server via a customer terminal and gaining membership by selecting a mileage provider, which a customer wants to join as a member, among affiliated mileage providers; issuing an integrated mileage card having a card number of predetermined digits to a joined member; and transmitting member information and the card number of the integrated mileage card from the integrated mileage service server to a mileage provider server of the mileage provider selected by the customer with the customer's consent.

According to yet another aspect of the invention, a method for supplying an integrated mileage service to accumulate or use mileage points using a system for supplying the integrated mileage service includes: inputting mileage accumulation or spending request data including a card number of an integrated mileage card presented by a customer to purchase a commodity, a payment amount, and member store ID information via a member store POS terminal; a mileage provider server receiving the mileage accumulation or spending request data from the member store POS terminal, confirming the card number of the integrated mileage card of the customer that requests to accumulate or use mileage points, and accumulating or deducting mileage points corresponding to the payment amount transmitted via the member store POS terminal to store the total sum of mileage points in a mileage DB of the mileage provider server; the mileage provider server transmitting an itemized statement of accumulation or use of mileage and a current mileage balance to the member store POS terminal; transmitting the itemized statement of accumulation or use of mileage and the current mileage balance, which are batch-processed at predetermined time intervals, from respective mileage provider servers to the integrated mileage service server when a plurality of mileage provider servers are used; and the integrated mileage service server storing the itemized statement of accumulation or use of mileage and the current mileage balance of each of the mileage provider servers in the integrated mileage DB and integratedly managing the stored information to provide the corresponding information stored in the integrated mileage DB to the customer terminal when receiving an inquiry about mileage accumulation from the customer terminal.

According to still another aspect of the invention, a system for supplying an integrated mileage service includes: a member store terminal for receiving mileage accumulation or spending request data including a card number of an integrated mileage card into which a plurality of membership cards are integrated, a payment amount, and member store ID information when a customer purchases a commodity; a mileage provider server for receiving the mileage accumulation or spending request data from the member store terminal and accumulating or deducting mileage points corresponding to the payment amount based on customer mileage information stored in a mileage DB to generate mileage accumulation or spending result data; and an integrated mileage service server for receiving itemized statements of accumulation or use of mileage points and a current mileage balance of the customer from each of mileage provider servers, storing the itemized statements and the current mileage balance in an integrated mileage DB, and integratedly managing the stored itemized statements and the current mileage balance as integrated mileage information to periodically inform the customer terminal of the integrated mileage information via an e-mail when a plurality of mileage provider servers are used.

According to further another aspect of the invention, a method for supplying an integrated mileage service to provide mileage information using a system for supplying the integrated mileage service includes: inputting mileage accumulation or spending request data including a card number of an integrated mileage card presented by a customer, a payment amount, and member store ID information via a member store terminal when the customer purchases a commodity; a mileage provider server receiving the mileage accumulation or spending request data from the member store terminal, confirming the card number of the integrated mileage card of the customer that requests to accumulate or use mileage points, accumulating or deducting mileage points corresponding to the payment amount, and storing accumulation of the mileage points or use of the mileage points in a mileage DB of the mileage provider server; transmitting information on the accumulation or use of the mileage points from each of mileage providers to the integrated mileage service server when a plurality of mileage provider servers are used; and storing the information on the accumulation or use of the mileage points of each of the mileage providers in an integrated mileage DB, integratedly managing the stored information as integrated mileage information, and periodically informing a customer terminal about the integrated mileage information via an e-mail.

According to further another aspect of the invention, a method for supplying an integrated mileage service includes: constructing an integrated mileage DB including member store related information and member information of each of affiliated mileage providers that consent to the integrated mileage service, which is embodied such that mileage points of one affiliated mileage provider are converted into mileage points of another affiliated mileage provider and used; constructing a member DB including service enrollment information having personal ID information required for using mileage points of one affiliated mileage provider at member stores of other affiliated mileage providers; providing a webpage, which is set such that a member selectively requests to convert set mileage points of one of already enrolled mileage providers into integrated mileage points usable at the member stores of other affiliated mileage providers, via a customer terminal of the member; converting set mileage points of a mileage provider, which is already joined and selected by the member, into the integrated mileage points usable at the member stores of other affiliated mileage providers, based on preset mileage conversion related information in response to the member's request for conversion of mileage points; and receiving mileage payment information along with member ID information from a member store terminal of a member store belonging to an affiliated mileage provider and deducting previously converted integrated mileage points based on the member ID information.

### BRIEF DESCRIPTION OF THE DRAWINGS

The above and other objects, features and advantages of the present invention will become more apparent to those of ordinary skill in the art by describing in detail exemplary embodiments thereof with reference to the attached drawings in which:

FIG. 1 is a block diagram showing the construction of an integrated mileage management system for supplying an integrated mileage service according to an exemplary embodiment of the present invention;

FIG. 2 is a flowchart illustrating a process of gaining membership in a method for supplying an integrated mileage service according to an exemplary embodiment of the present invention;

FIG. 3 is a flowchart illustrating a process of accumulating mileage points in a method for supplying an integrated mileage service according to an exemplary embodiment of the present invention;

FIG. 4 is a flowchart illustrating a process of spending mileage points in a method for supplying an integrated mileage service according to an exemplary embodiment of the present invention;

FIG. 5 is a block diagram showing the construction of a system for supplying an integrated mileage service according to another exemplary embodiment of the present invention;

FIG. 6 is a flowchart illustrating a process of accumulating mileage points in a method for supplying an integrated mileage service according to another exemplary embodiment of the present invention;

FIG. 7 is a flowchart illustrating a process of spending mileage points in a method for supplying an integrated mileage service according to another exemplary embodiment of the present invention;

FIG. 8 is a block diagram showing the construction of a system for supplying an integrated mileage service according to yet another exemplary embodiment of the present invention;

FIG. 9 is a flowchart illustrating a process of providing mileage information in a method for supplying an integrated mileage service according to an exemplary embodiment of the present invention:

FIG. 10 is a block diagram showing the construction of an integrated mileage server of a system for supplying an integrated mileage service according to an exemplary embodiment of the present invention;

FIG. 11 is a flowchart illustrating a method for supplying an integrated mileage service using the integrated mileage server shown in FIG. 10, according to an exemplary embodiment of the present invention;

FIG. 12 is a block diagram showing the construction of an integrated mileage server of a system for supplying an integrated mileage service according to another exemplary embodiment of the present invention;

FIG. 13 is a flowchart illustrating a method for supplying an integrated mileage service using the integrated mileage server shown in FIG. 12, according to an exemplary embodiment of the present invention;

FIG. 14 is a block diagram showing the construction of an integrated mileage server of a system for supplying an integrated mileage service according to yet another exemplary embodiment of the present invention; and

FIG. 15 is a flowchart illustrating a method for supplying an integrated mileage service using the integrated mileage server shown in FIG. 14, according to an exemplary embodiment of the present invention.

### DETAILED DESCRIPTION

Hereinafter, the construction and operation of systems for supplying an integrated mileage service and methods performed using the systems according to exemplary embodiments of the present invention will be described in detail with reference to the accompanying drawings.

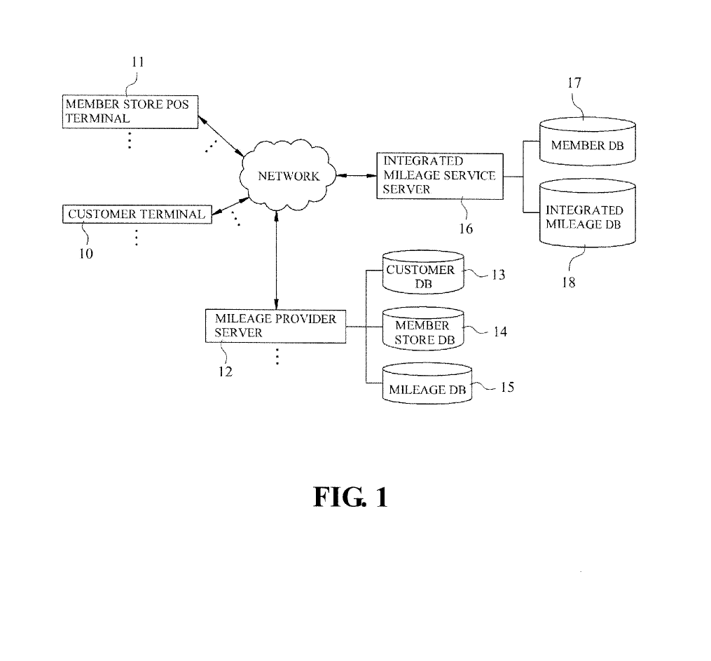

FIG. 1 is a block diagram showing the construction of a system for supplying an integrated mileage service according to an exemplary embodiment of the present invention.

The system for supplying the integrated mileage service shown in FIG. 1 includes a customer terminal 10, a member store point of sale (POS) terminal 11, a mileage provider server 12, and an integrated mileage service server 16. The member store POS terminal 11 receives mileage accumulation or spending request data including a card number of an integrated mileage card into which a plurality of membership cards are integrated, a payment amount, and member store identification (ID) information when a customer purchases a commodity. The mileage provider server 12 receives the mileage accumulation or spending request data from the member store POS terminal 11, accumulates or spends mileage points corresponding to the payment amount based on customer mileage information previously stored in a mileage database (DB) 15, and generates the corresponding result data. When a plurality of mileage provider servers 12 are used, the integrated mileage service server 16 receives itemized statements of accumulation or use of mileage points and a current mileage balance of the customer, which are batch-processed at predetermined time intervals, from the respective mileage provider servers 12, stores the itemized statements and the current mileage balance in an integrated mileage DB 18, integratedly manages the stored itemized statements and the current mileage balance, and provides an integrated mileage inquiry service.

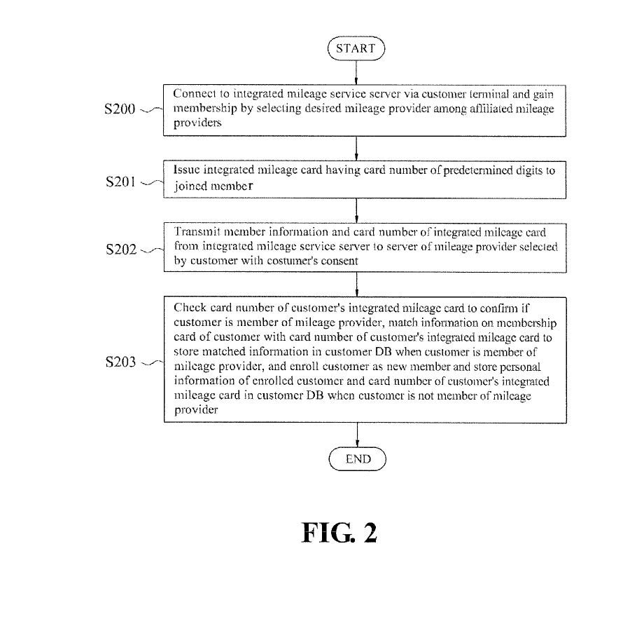

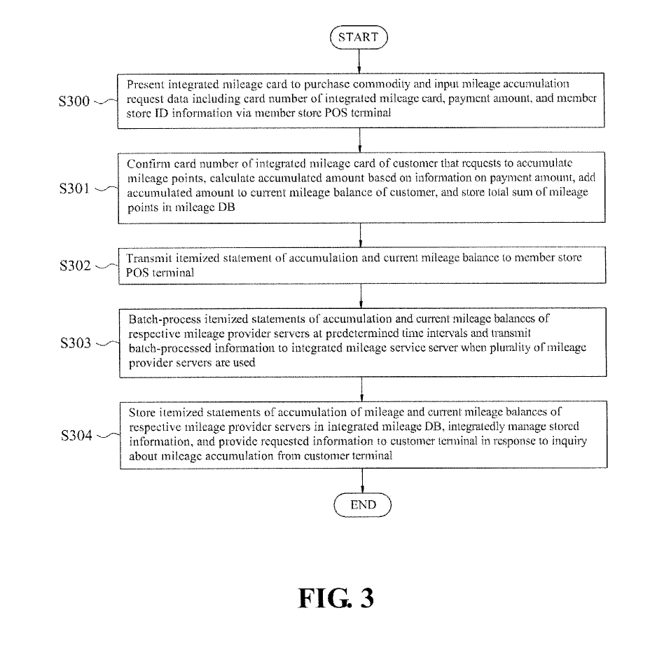

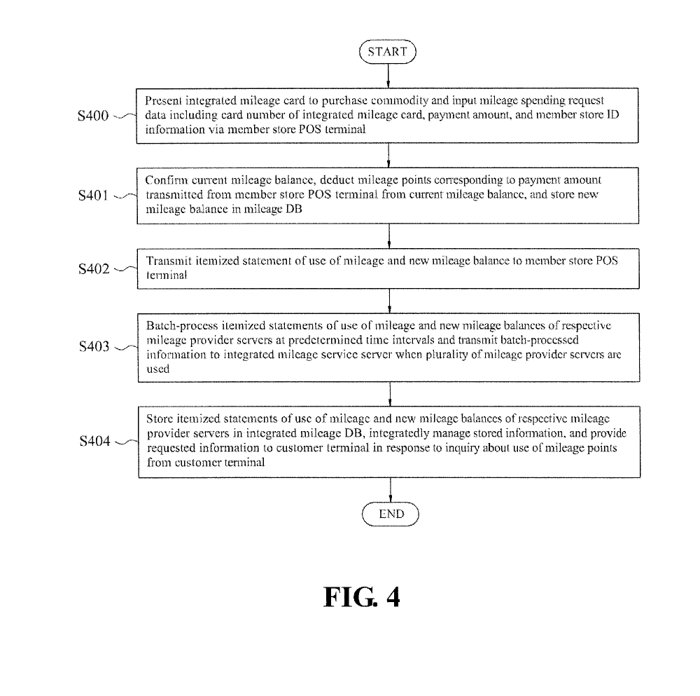

FIG. 2 is a flowchart illustrating a process of gaining membership in a method for supplying an integrated mileage service according to an exemplary embodiment of the present invention. FIG. 3 is a flowchart illustrating a process of accumulating mileage points in a method for supplying an integrated mileage service according to an exemplary embodiment of the present invention. FIG. 4 is a flowchart illustrating a process of spending mileage points in a method for supplying an integrated mileage service according to an exemplary embodiment of the present invention.

Initially, a process of gaining membership in a method for providing an integrated mileage service according to an embodiment of the present invention will be described with reference to FIGS. 1 and 2.

In step S200, a customer connects to the integrated mileage service server 16 via the customer terminal 10, such as a personal computer (PC), and gains membership and also, selects a mileage provider, which the customer wants to join as a member, among mileage providers affiliated with the integrated mileage service enterprise.

In this case, member information is provided only to the mileage provider selected by the customer.

While gaining membership, the customer inputs member information, such as an ID, a password, a name, a resident registration number, a present address, an e-mail address, to the customer terminal 10.

When the customer's enrollment as a member is finished, the integrated mileage service enterprise issues an integrated mileage card having a card number of predetermined digits (e.g., a 16-digit member number) to the enrolled member in step S201.

In step S202, with the customer's consent, the integrated mileage service server 16 stores the member information input during the member enrollment and the card number of the integrated mileage card in a member DB 17 and an integrated mileage DB 18 and transmits the same to the mileage provider server 12 of the mileage provider selected by the customer during the member enrollment.

In this case, the mileage provider server 12 receives the member information and the card number of the integrated mileage card from the integrated mileage service server 16 and stores the same in a customer DB 13 and the mileage DB 15.

Thus, when receiving mileage accumulation or spending request data from the member store POS terminal 11, the mileage provider server 12 checks the card number of the customer's integrated mileage card and confirms if the customer is a member of the corresponding mileage provider.

As a result, in step S203, when the customer is certified as the member of the mileage provider, the mileage provider server 12 matches information on a membership card of the customer with the card number of the customer's integrated mileage card and stores the matched information in the customer DB 13. Also, when the customer is not certified as the member of the corresponding mileage provider, the mileage provider server 12 enrolls the customer as a new member and stores personal information of the enrolled customer and the card number of the customer's integrated mileage card in the customer DB 13.

Hereinafter, a process of accumulating mileage points in a method for supplying an integrated mileage service according to an exemplary embodiment of the present invention will be described with reference to FIGS. 1 and 3.

In step S300, a customer presents an integrated mileage card to purchase a commodity, and mileage accumulation request data including a card number of the integrated mileage card, a payment amount, and member store ID information is input via the member store POS terminal 11.

In step S301, when receiving the mileage accumulation request data via the member store POS terminal 11, the mileage provider server 12 confirms the card number of the integrated mileage card of the customer that requests to accumulate mileage points, calculates an accumulated amount based on the received information on the payment amount, adds the accumulated amount to a current mileage balance of the customer, and stores the total sum of mileage points in the mileage DB 15 of the mileage provider server 12.

Subsequently, the mileage provider server 12 transmits an itemized statement of accumulation and a new current mileage balance to the member store POS terminal 11 to inform the customer of the same in step S302.

When a plurality of mileage provider servers 12 are used as shown in FIG. 1, the integrated mileage service server 16 receives the itemized statements of accumulation and the current mileage balances, which are batch-processed at predetermined time intervals, from the respective mileage provider servers 12 in step S303.

The integrated mileage service server 16 stores the itemized statement of accumulation and the current mileage balance of each of the mileage provider servers 52 in the integrated mileage DB 18 and integratedly manages the stored information. When receiving an inquiry about mileage accumulation from the customer terminal 10, the integrated mileage service server 16 reads the corresponding information from the integrated mileage DB 18 and provides the information to the customer terminal 10 in step S304.

Hereinafter, a process of spending mileage points in a method of supplying an integrated mileage service according to an exemplary embodiment of the present invention will be described with reference to FIGS. 1 and 4.

In step S400, a customer presents an integrated mileage card to purchase a commodity, and mileage accumulation request data including a card number of the integrated mileage card, a payment amount, and member store ID information is input via the member store POS terminal 11.

In step S401, when receiving the mileage spending request data via the member store POS terminal 11, the mileage provider server 12 confirms the card number of the integrated mileage card of the customer that requests to use mileage points, deducts mileage points corresponding to the payment amount of the commodity transmitted from the member store POS terminal 11 from a current mileage balance, and stores the remaining mileage points (i.e., new mileage balance) in the mileage DB 15.

Subsequently, the mileage provider server 12 transmits an itemized statement of use of mileage and the current mileage balance to the member store POS terminal 11 to inform the customer of the same in step S402.

When a plurality of mileage provider servers 12 are used as shown in FIG. 1, the integrated mileage service server 16 receives the itemized statements of use of mileage and the current mileage balances, which are batch-processed at predetermined time intervals, from the respective mileage provider servers 12 in step S403.

The integrated mileage service server 16 stores the itemized statement of use of mileage and the current mileage balance of each of the mileage provider servers 12 in the integrated mileage DB 18 and integratedly manages the stored information. When receiving an inquiry about use of mileage from the customer terminal 10, the integrated mileage service server 16 reads the corresponding information from the integrated mileage DB 18 and provides the information to the customer terminal 10 in step S404.

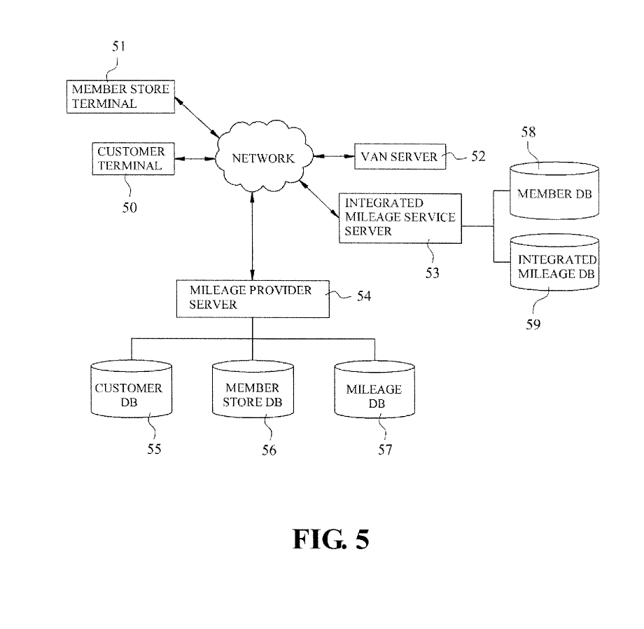

FIG. 5 is a block diagram showing the construction of a system for supplying an integrated mileage service according to another exemplary embodiment of the present invention.

The system for supplying the integrated mileage service shown in FIG. 5 includes a customer terminal 50, a member store terminal 51, a value-added network (VAN) server 52, an integrated mileage service server 53, and a mileage provider server 54. Specifically, the customer terminal 50 may be a personal computer (PC). The member store terminal 51 receives mileage accumulation or spending request data including a card number of an integrated mileage card into which a plurality of membership cards are integrated, a payment amount, and member store identification (ID) information when a customer purchases a commodity. The VAN server 52 receives the mileage accumulation or spending request data from the member store terminal 51 determines if the mileage accumulation or spending request data is related to information on accumulation of mileage points or information on use of the mileage points, and authorizes the accumulation or use of the mileage points. When the VAN server 52 authorizes the accumulation or use of the mileage points, the integrated mileage service server 53 receives the mileage accumulation or spending request data and functions as a hub to provide a mileage service for each mileage provider selected by the customer based on the card number of the integrated mileage card. The mileage provider server 54 accumulates or spends mileage points corresponding to the payment amount based on customer mileage information previously stored in a mileage DB 57 in response to the mileage accumulation or spending request data transmitted via the integrated mileage service server 53, generates the corresponding result data, transmits the result data to the member store terminal 51 via the integrated mileage service server 53 and the VAN server 52.

Also, the member store terminal 51 may be a POS terminal or a credit card terminal, and the customer can confirm accumulation of mileage points or use of mileage points via a slip printed by the member store terminal 51.

Also, the integrated mileage card is issued by an integrated mileage service enterprise, which provides mileage services to affiliated mileage providers, and is recognizable by a POS terminal or a credit card terminal. The integrated mileage card may be any one of a magnetic card having a card number of predetermined digits, an integrated circuit (IC)-chip-embedded card, and a barcode-recorded card.

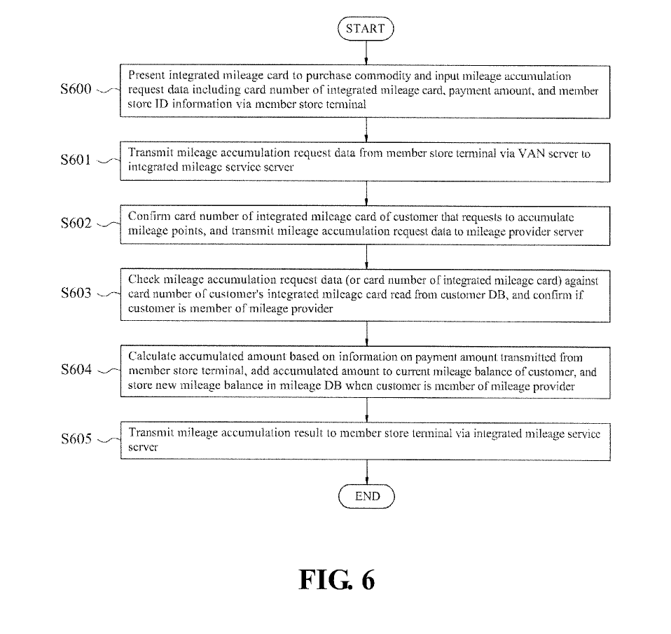

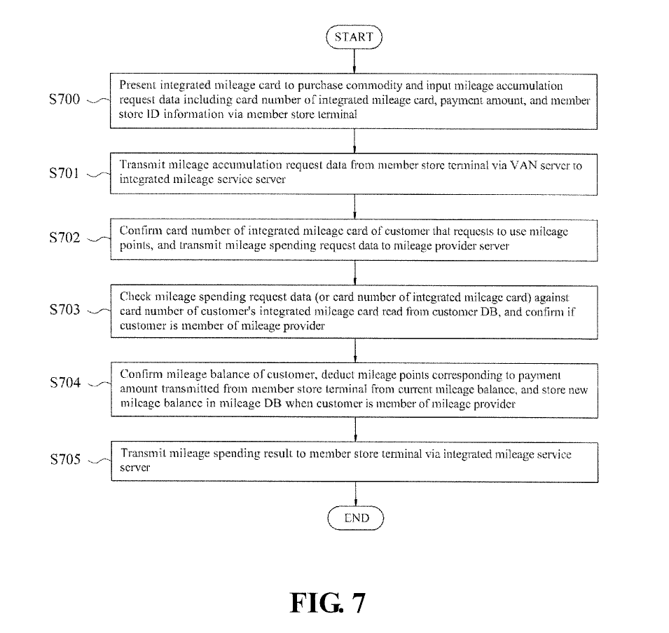

FIG. 6 is a flowchart illustrating a process of accumulating mileage points in a method for supplying an integrated mileage service according to another exemplary embodiment of the present invention. FIG. 7 is a flowchart illustrating a process of spending mileage points in a method for supplying an integrated mileage service according to another exemplary embodiment of the present invention.

A process of accumulating mileage points in a method for supplying an integrated mileage service according to another exemplary embodiment of the present invention will now be described with reference to FIGS. 5 and 6.

In step S600, a customer presents an integrated mileage card to purchase a commodity, and mileage accumulation request data including a card number of the integrated mileage card, a payment amount, and member store ID information is input via the member store terminal 51.

In step S601, when the mileage accumulation request data is input via the member store terminal 51, the VAN server 52 receives the mileage accumulation request data via a credit transaction network, determines if the mileage accumulation request data is related to information on accumulation of mileage points, and transmits the mileage accumulation request data to the integrated mileage service server 53 via a network, such as the Internet.

For reference, the network is a general expression including not only an exclusive network, which connects only the member store terminal 51 and the VAN server 52, but also an inclusive network, such as the Internet, which connects the VAN server 52 and the integrated mileage service server 53. For example, the network may include only a single kind of network or various kinds of networks.

Thereafter, the integrated mileage service server 53 confirms the card number of the integrated mileage card of the customer that requests to accumulate mileage points, and transmits the mileage accumulation request data to the mileage provider server 54 in step S602.

When receiving the mileage accumulation request data, the mileage provider server 54 checks the mileage accumulation request data (i.e., the card number of the integrated mileage card) against the card number of the customer's integrated mileage card stored in the customer DB 55, and confirms if the customer is a member of the mileage provider in step S603.

In step S604, when the customer is certified as the member of the mileage provider, the mileage provider server 54 calculates an accumulated amount based on information on the payment amount, which is transmitted from the member store terminal 51, adds the accumulated amount to a current mileage balance of the customer, and stores the total sum of mileage points in the mileage DB 57.

Subsequently, the mileage provider server 54 transmits mileage accumulation result data to the member store terminal 51 via the integrated mileage service server 53 and the VAN server 52 in step S605.

When the mileage accumulation result data is transmitted to the member store terminal 51, the customer can confirm the accumulation of mileage points via a slip printed by a POS terminal or a credit card terminal, which is used as the member store terminal 51.

Here, when receiving an inquiry about mileage accumulation from the customer terminal 50, the integrated mileage service server 53 may provide an itemized statement of accumulation of mileage points stored in an integrated mileage DB 59 to the customer terminal 50.

Hereinafter, a process of spending mileage points in a method of supplying an integrated mileage service according to another exemplary embodiment of the present invention will be described with reference to FIGS. 5 and 7.

In step S700, a customer presents an integrated mileage card to purchase a commodity, and mileage spending request data including a card number of the integrated mileage card, a payment amount, and member store ID information is input via the member store terminal 51.

In step S701, when the mileage spending request data is input via the member store terminal 51, the VAN server 52 receives the mileage spending request data via a credit transaction network, determines if the mileage spending request data is related with information on use of mileage points, and transmits the mileage spending request data to the integrated mileage service server 53 via a network, such as the Internet.

Thereafter, the integrated mileage service server 53 confirms the received card number of the customer's integrated mileage card and transmits the mileage spending request data to the mileage provider server 54 again in step S702.

When receiving the mileage spending request data, the mileage provider server 54 checks the mileage use request data (i.e., the card number of the integrated mileage card) against the card number of the customer's integrated mileage card stored in the customer DB 55, and confirms if the customer is a member of the mileage provider in step S703.

In step S704, when the customer is certified as the member of the mileage provider, the mileage provider server 54 confirms a current mileage balance of the customer, deducts mileage points corresponding to the payment amount of the commodity transmitted from the member store terminal 51 from the current mileage balance, and stores the remaining mileage points (i.e., new mileage balance) in the mileage DB 57.

The mileage provider server 54 transmits a mileage spending result to the member store terminal 51 via the integrated mileage service server 53 and the VAN server 52 in step S705.

When the mileage spending result data is transmitted to the member store terminal 51, the customer can confirm the use of mileage points via a slip printed by a POS terminal or a credit card terminal, which is used as the member store terminal 51.

Here, when receiving an inquiry about use of mileage from the customer terminal 50, the integrated mileage service server 53 may provide an itemized statement of use of mileage points stored in an integrated mileage DB 59 to the customer terminal 50.

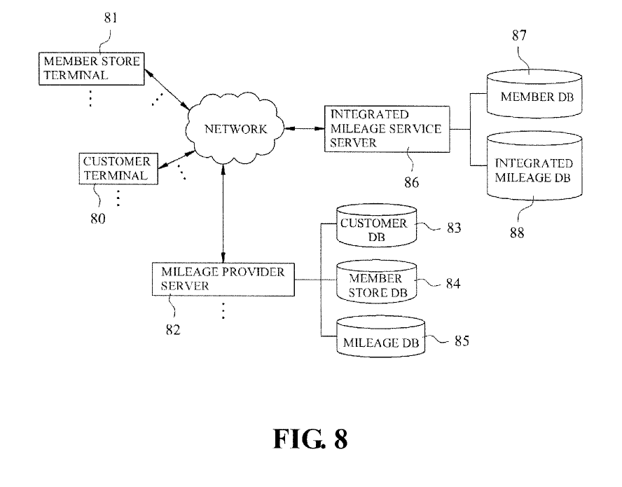

FIG. 8 is a block diagram showing the construction of a system for supplying an integrated mileage service according to yet another exemplary embodiment of the present invention.

The system for supplying the integrated mileage service shown in FIG. 8 includes a customer terminal 80, a member store terminal 81, a mileage provider server 82, and an integrated mileage service server 86. Specifically, the member store terminal 81 receives mileage accumulation or spending request data including a card number of an integrated mileage card, a payment amount, and member store ID information when a customer purchases a commodity. The mileage provider server 82 receives the mileage accumulation or spending request data from the member store terminal 81, accumulates or deducts mileage points corresponding to the payment amount based on customer mileage information stored in a mileage DB 85, and generates mileage accumulation or spending result data. When a plurality of mileage provider servers 82 are used, the integrated mileage service server 86 receives itemized statements of accumulation or use of mileage points and a current mileage balance of the customer from the respective mileage provider servers 82, stores the itemized statements and the current mileage balance in an integrated mileage DB 88, integratedly manages the stored itemized statements and the current mileage balance as integrated mileage information, and periodically informs the customer terminal 80 of the integrated mileage information via an e-mail.

Also, the integrated mileage information includes the type of business and name of a member store, a mileage grade, accumulated/spent mileage amounts, a current mileage balance, and information about the latest accumulation or use of mileage points.

Further, the member store terminal 81 may be a POB terminal or a credit card terminal, and the customer can confirm accumulation of mileage points or use of mileage points via a slip printed by the member store terminal 81.

Also, the integrated mileage card is issued by an integrated mileage service enterprise, which provides mileage services to affiliated mileage providers, and is recognizable by a POS terminal or a credit card terminal. The integrated mileage card may be any one of a magnetic card having a card number of predetermined digits, an IC-chip-embedded card, and a barcode-recorded card.

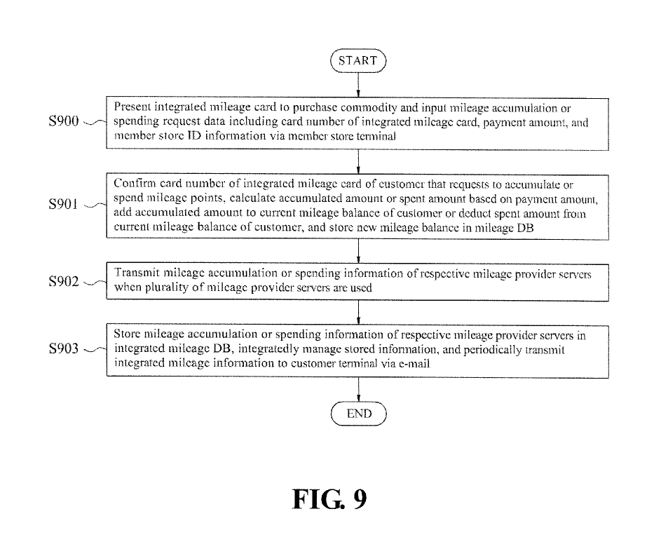

FIG. 9 is a flowchart illustrating a process of providing mileage information in a method for supplying an integrated mileage service according to an exemplary embodiment of the present invention.

A customer connects to the integrated mileage service server 86, which functions as the hub to provide the integrated mileage service, via the customer terminal 80, such as a PC, and gains membership and also, selects a mileage provider, which the customer wants to join as a member, among mileage providers affiliated with the integrated mileage service enterprise.

While gaining membership, the customer inputs member information, such as an ID, a password, a name, a resident registration number, a present address, an e-mail address, to the customer terminal 80. The integrated mileage service server 86 receives the member information from the customer terminal 80, registers the member information in a customer DB 87, and transmits the member information and a card number of an integrated mileage card to be issued to the customer only to the mileage provider selected by the customer. Also, the integrated mileage service enterprise issues the integrated mileage card having a card number of predetermined digits (e.g., a 16-digit member number) to the customer who is enrolled as a member.

Meanwhile, the mileage provider receives the member information from the integrated mileage service enterprise and looks up key values, such as the resident registration number, to confirm if the customer is an enrolled member. When the customer is a member of the mileage provider, card numbers are given to a card issued by the mileage provider and an integrated mileage card, respectively, to separately or integratedly accumulate mileage points. When the customer is not a member of the mileage provider, the customer is enrolled as a new member to accumulate mileage points. Accordingly, when the already enrolled customer accumulates or spends mileage points at a member store, mileage points can be integratedly managed using either one of the card issued by the mileage provider and the integrated mileage card. In order to confirm if the customer is the enrolled member, when the customer already possesses the card issued by the mileage provider during enrollment in the integrated mileage service, the card number of the possessed card may be input, provided to the mileage provider, and looked up as a key value. Alternatively, the resident registration number of the customer or the customer's name and the date of the customer's birth may be looked up as key values.

After the customer's enrollment as a member in the integrated mileage service is finished as described above, when the customer purchases a commodity at the member store, the customer presents the integrated mileage card, and mileage accumulation request data including information about the integrated mileage card, a payment amount, and member store ID information is input via the member store terminal 81 in step S900.

For reference, a network, which connects the customer terminal 80, the member store terminal 81, the mileage provider server 82, and the integrated mileage service server 86 as shown in FIG. 8, is a general expression including not only an exclusive network, which connects only the member store terminal 81 and a VAN network or a POS network, but also an inclusive network, such as the Internet, which is connected to the integrated mileage service server 86. For example, the network may include only a single kind of network or various kinds of networks.

Subsequently, in step S901, when receiving mileage accumulation request data or mileage spending request data via the member store terminal 81, the mileage provider server 82 confirms the card number of the integrated mileage card of the customer that requests to accumulate or spend mileage points, calculates an accumulated amount or a spent amount based on the received information on the payment amount, and adds the accumulated amount to a current mileage balance of the customer, or stores information about a mileage spending result and the current mileage balance in the mileage DB 85.

In this case, the mileage provider server 82 transmits information about a mileage accumulation result and the accumulated amount or information about total mileage spent and the current mileage balance to the member store terminal 81 to inform the customer of the same.

When a plurality of mileage provider servers 82 are used as shown in FIG. 8, the integrated mileage service server 86 receives mileage accumulation information or mileage spending information from the respective mileage provider servers 82 in step S902.

In step S903, the integrated mileage service server 86 stores the mileage accumulation information or mileage spending information of each of the mileage provider servers 82 in the integrated mileage DB 88, integratedly manages the stored information, and informs the customer terminal 80 of the integrated mileage information via an e-mail periodically, for example, weekly or monthly.

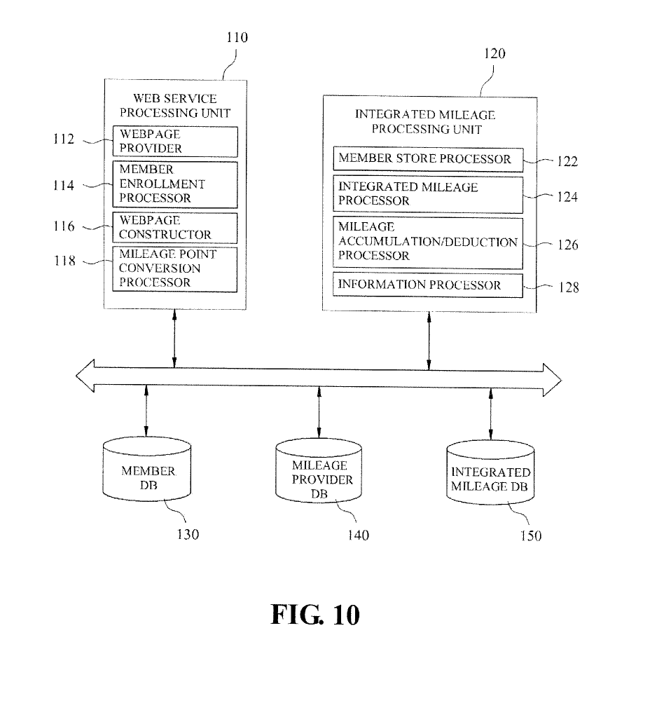

FIG. 10 is a block diagram showing the construction of an integrated mileage server of a system for supplying an integrated mileage service according to an exemplary embodiment of the present invention.

Referring to FIG. 10, the integrated mileage server includes a web service processing unit 110, an integrated mileage processing unit 120, a member DB 130, a mileage provider DB 140, and an integrated mileage DB 150.

The web service processing unit 110 provides a webpage, which is set such that a member can input member enrollment information to apply for a mileage point enterprise conversion service, and provides the present state of use of mileage points on the webpage at the request made by the member via an Internet terminal. Here, the mileage point enterprise conversion service is embodied such that a member of a mileage provider can spend mileage points even at member stores of other mileage providers. Also, the web service processing unit 110 provides a webpage, which is set such that a member of a mileage provider can request to convert mileage points of the already enrolled mileage provider into integrated mileage points via the web, so that the member of the mileage provider can spend mileage points also at member stores of other mileage providers. Further, the web service processing unit 110 registers the integrated mileage points by matching the integrated mileage points with member ID information of the integrated mileage DB 150 and also, deducts the mileage points of the mileage provider by matching the mileage points with information on the corresponding mileage provider and member stored in the mileage provider DB 140. For this, the web service processing unit 110 includes a webpage provider 112, a member enrollment processor 114, a webpage constructor 116, and a mileage point conversion processor 118. Specifically, the webpage provider 112 provides a constructed webpage to an Internet terminal that requests to receive the webpage. The member enrollment processor 114 registers member enrollment information required for applying for an integrated mileage service and processes the member enrollment information. The webpage constructor 116 loads the corresponding information from the mileage provider DB 140 in response to a member's inquiry about mileage related information and constructs the corresponding webpage. The mileage point conversion processor 118 processes conversion of mileage points of a mileage provider into integrated mileage points. Here, the mileage point conversion processor 118 may convert set mileage points of a mileage provider that is already joined and selected by a member into reference points based on preset conversion related information and register the reference points by matching the reference points with member ID information, so that the set mileage points of the selected mileage provider can be commonly used in affiliated mileage providers. Alternatively, the mileage point conversion processor 118 may convert the set mileage points of the mileage provider, which is already joined and selected by the member, into mileage points of another mileage provider, which is selected by the member among the affiliated mileage providers, based on the preset conversion related information, and register the mileage points of another selected mileage provider by matching the mileage points of the selected another mileage provider and ID information of the selected another mileage provider with the member ID information. Therefore, the integrated mileage point can be understood as a general expression including not only the reference points but also the mileage points of the another mileage provider selected by the member.

The integrated mileage processing unit 120 receives payment information including member store ID information and integrated mileage card ID information from a member store terminal and determines if the corresponding member store belongs to an affiliated mileage provider by searching the member DB 130 and the integrated mileage DB 140 based on the received information. Thus, when the member store is certified as a member of the affiliated mileage provider, the integrated mileage processing unit 120 determines if the corresponding member store belongs to a mileage provider that a customer has joined as a member. Thus, when it is determined that the member store belongs to the mileage provider that the customer has joined, the integrated mileage processing unit 120 accumulates or deducts mileage points depending on the payment information of the customer. When the member store does not belong to a mileage provider of which mileages points are converted into integrated mileage points at the request of the member, the integrate mileage processing unit 120 deducts previously converted integrated mileage points based on the payment information of the member. Also, the integrated mileage processing unit 120 informs the corresponding member store terminal about a payment processing result of the integrated mileage points of the member, and informs a server of the mileage provider to which the corresponding member store belongs and a server of the already-enrolled mileage provider of which mileage points are converted into the integrated mileage points at the request of the member, about a payment processing result. For this, the integrated mileage processing unit 120 may include a member store processor 122, an integrated mileage processor 124, a mileage accumulation/deduction processor 126, and an information processor 128. Specifically, the member store processor 122 determines if a member store belongs to a mileage provider that a member has joined based on payment information and integrated mileage card information and informs the member store of a mileage point processing result. When it is determined that the member store does not belong to the mileage provider that member has joined, the integrated mileage processor 124 deducts integrated mileage points. When it is determined that the member store belongs to the mileage provider that the member has joined, the mileage accumulation/deduction processor 126 accumulates or deducts mileage points in the corresponding mileage provider based on the payment information. The information processor 128 informs the corresponding mileage provider about use of the member's mileage points.

Personal information including ID of individuals that apply for an integrated mileage service in order to use mileage points at an enterprise that the individuals have personally joined via an Internet website and even at mileage providers that the individuals have not joined, is registered in the member DB 130. Here, the personal information includes a name, a present address, a telephone number, an age, a resident registration number, and a portable phone number of a member and the resident registration number or the portable phone number may be used as member ID information. Also, when an integrated mileage card that can be commonly used in respective mileage providers is issued, information on the integrated mileage card is further registered.

Member store related information and member information are matched with ID information of each mileage provider and registered in the mileage provider DB 140. The member store related information includes member store ID information of each of mileage providers that consent to the integrated mileage service, which is embodied such that mileage points of one of affiliated mileage providers can be converted into mileage points of another affiliated mileage provider and used.

Information on integrated mileage points into which the member requests to convert mileage points of a mileage provider and conversion related information of mileage providers related with conversion of integrated mileage points are matched with member ID information and registered in the integrated mileage DB 150. Here, the information on the integrated mileage points may be matched with the member ID information and registered in the member DB 130 or registered in the mileage provider DB 140.

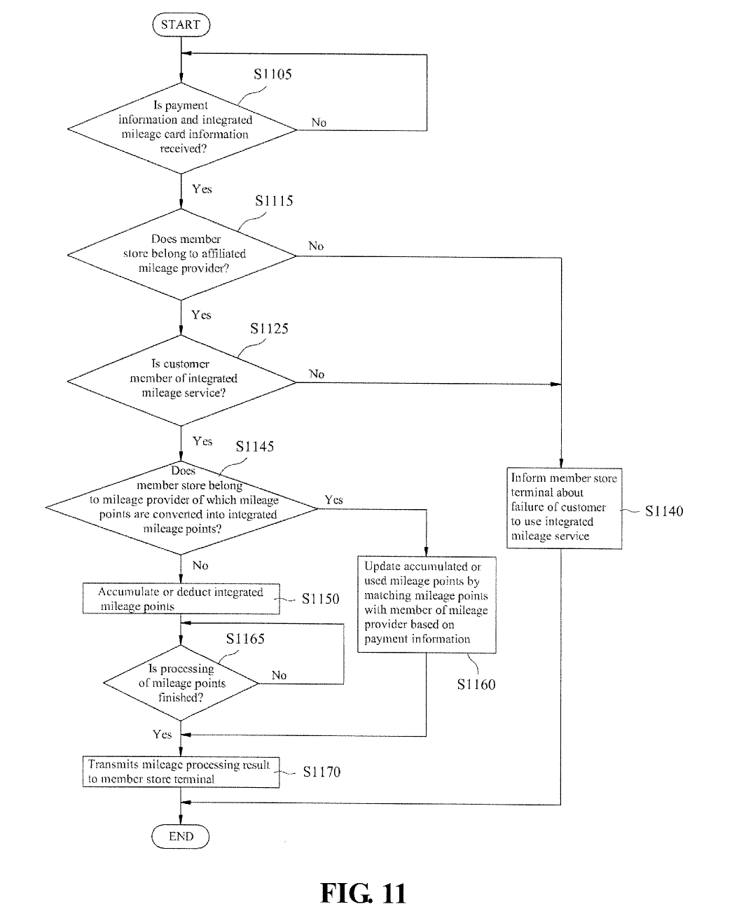

FIG. 11 is a flowchart illustrating a method for supplying an integrated mileage service using the integrated mileage server shown in FIG. 10, according to an exemplary embodiment of the present invention.

When a customer who is enrolled as a member in an integrated mileage service purchases goods or a service at a member store of an affiliated mileage provider, the customer may present an integrated mileage card to the member store during payment and request to accumulate or spend mileage points. Meanwhile, even if the member store does not belong to the mileage provider that the customer has joined, the customer may present the integrated mileage card and request to use previously converted integrated mileage points at the member store.

As described above, when the system receives integrated mileage card information and payment information including member store ID information and use of mileage points via the member store terminal in response to the customer's request in step S1105, the integrated mileage processing unit 120 looks up the member store ID information transmitted via the member store processor 122 in the mileage provider DB 140 and determines if the member store belongs to the affiliated mileage provider in step S1115. Thus, when the corresponding member store belongs to the affiliated mileage provider, the integrated mileage processing unit 120 looks up the integrated mileage card information in the member DB 130 and determines if the customer is a member of the integrated mileage service in step S1125. In this case, when it is determined that the member store does not belong to the affiliated mileage provider or the customer is not a member, the member store processor 122 informs the corresponding member store terminal that the integrated mileage service cannot be provided in step S1140. Meanwhile, when the member store belongs to the affiliated mileage provider and the customer is certified as a member based on the integrated mileage card ID information, the integrated mileage processing unit 120 determines if the corresponding member store belongs to a mileage provider that the customer has already joined in step S1145. Thus, when the member store belongs to the mileage provider that the customer has already joined, the mileage accumulation/deduction processor 126 accumulates or deducts mileage points, which are matched with the corresponding member of the corresponding mileage provider based on the payment information of the member, and registered in the mileage provider DB 140 in step S1150. Meanwhile, when it is determined that the member store does not belong to the mileage provider of which mileage points are converted into integrated mileage points by the member, the integrated mileage processor 124 of the integrated mileage processing unit 120 deducts integrated mileage points, which are matched with the member ID information and registered in the integrated mileage DB 150 in step S1160. In this case, when the integrated mileage points are insufficient for payment, the member store processor 122 of the integrated mileage processing unit 120 may inform the corresponding member store terminal about a shortage of mileage points.

When processing of mileage points is finished as described above in step S1165, the integrated mileage processing unit 120 transmits a result of the processing of the member's mileage points to the corresponding member store in step S1170, so that the member can get a receipt for the present state of integrated mileage points at the member store.

Meanwhile, in the system for supplying the integrated mileage service, a web service is provided so that a customer that has joined the integrated mileage service can confirm information on accumulated or deducted mileage points based on the customer's payment information at the member store of the affiliated mileage provider. Specifically, when the customer makes access to a webpage provided by the system via a customer terminal, inputs a previously registered member ID and password, and asks an inquiry about the information on the accumulated or spent mileage points, the web service processing unit 110 loads the present state of accumulation or use of mileage points of the member and mileage information, which are matched with the mileage provider that is joined by the member and registered in the mileage provider DB 140, constructs a webpage using the webpage constructor 112, and transmits the webpage to the customer terminal of the member that asks the inquiry. Thus, the member can readily confirm the present states of the accumulated/deducted mileage points and use of integrated mileage points.

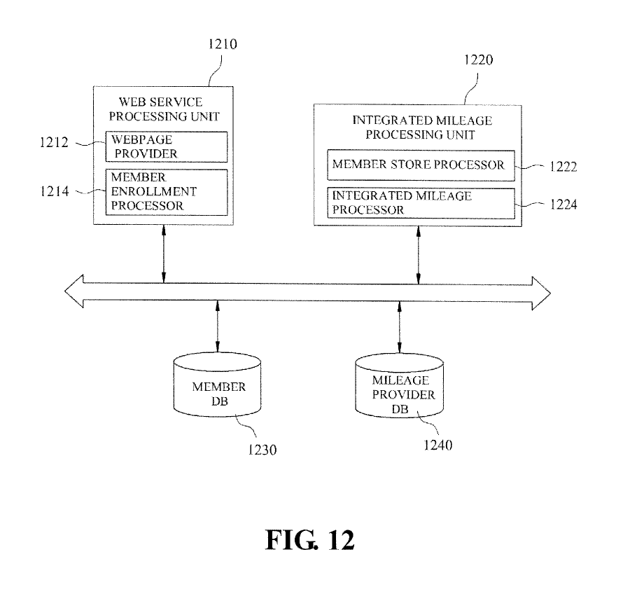

FIG. 12 is a block diagram showing the construction of an integrated mileage server of a system for supplying an integrated mileage service according to another exemplary embodiment of the present invention.

Referring to FIG. 12, the integrated mileage server includes a web service processing unit 1210, an integrated mileage processing unit 1220, a member DB 1230, and an integrated mileage DB 1240.

The web service processing unit 1210 includes a webpage provider 1212 and a member enrollment processor 1214. The web provider 1212 provides a webpage that is set such that individuals can input personal ID information via a customer terminal and input enrollment information of at least one mileage provider that the individuals have personally joined so as to apply for an integrated mileage service. The member enrollment processor 1214 registers the personal ID information, which is input to gain membership, and the enrollment information of the mileage provider, which is input to apply for the integrated mileage service, and processes the registered information.

The integrated mileage processing unit 1220 receives payment information including the personal ID information and the member store ID information from an arbitrary member store terminal, searches the member DB 1230 and the integrated mileage DB 1240 based on the received personal ID information and member store ID information, and determines if a customer is a member of an affiliated mileage provider and if a member store belongs to the affiliated mileage provider. Thus, when it is determined that the customer is the member and the member store belongs to the affiliated mileage provider, the integrated mileage processing unit 1220 transmits the preset personal ID information along with the payment information to the corresponding mileage provider server so that mileage points corresponding to a payment amount are accumulated in the mileage provider to which the member store belongs.

Personal information of a member that applies for the integrated mileage service and enrollment information of a mileage provider joined personally by the member among affiliated mileage providers are registered in the member DB 1230. The personal information includes a name, a present address, a telephone number, an age, a resident registration number, and a portable phone number of the member. The enrollment information of the mileage provider includes a credit card number and a mileage card number.

Information on at least one affiliated mileage provider and member store related information including member store ID information of member stores belonging to each mileage provider are registered in the integrated mileage DB 1240.

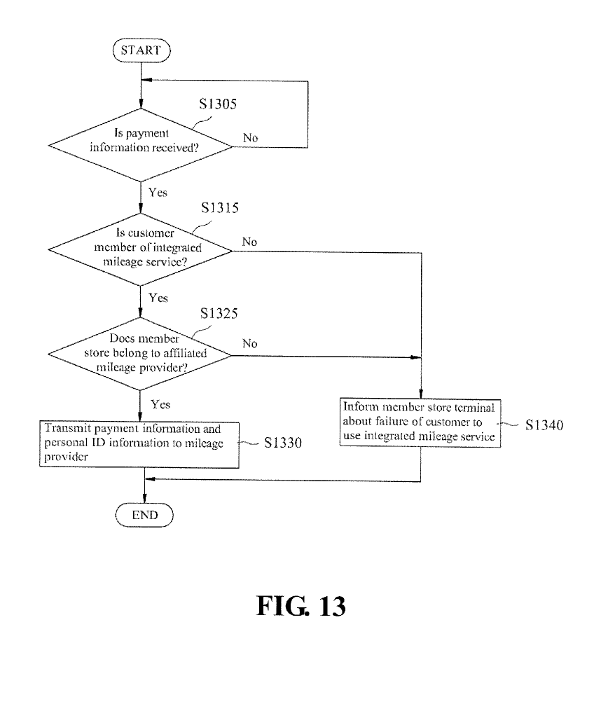

FIG. 13 is a flowchart illustrating a method for supplying an integrated mileage service using the integrated mileage server shown in FIG. 12, according to an exemplary embodiment of the present invention.

Initially, it is assumed that an individual makes access to a webpage of an integrated mileage service server via a customer terminal, such as a PC, in order to get an integrated mileage service provided by the system, inputs personal information, and selects a mileage provider that the individual wants to personally join as a member among affiliated mileage providers, so personal ID information is registered in the member DB 1230.

When a customer who is enrolled as a member in the integrated mileage service purchases a commodity at a member store, even if the customer does not possess a mileage card of the member store, the customer can present personal ID information to the member store and request to accumulate mileage points. In this case, a resident registration number or a portable phone number of the customer may be the personal ID information. Alternatively, the card number of a credit card or a mileage card that is previously registered in the system and carried by the customer may be used as the personal ID information. In response to the customer's request, the member store transmits payment information including the personal ID information and member store ID information via a member store terminal to the system. When the system receives the payment information in step S1305, the member store processor 1222 of the integrated mileage processing unit 1220 searches the member DB 1220 based on the personal ID information included in the payment information and determines if the customer is the member of the integrated mileage service in step S1315. When the customer is certified as the member based on the personal ID information, the member store processor 1222 searches the integrated mileage DB 1230 based on the member store ID information and determines if the member store belongs to the affiliated mileage provider in step S1325. In this case, when it is determined that the customer is the member and the member store belongs to the mileage provider, the mileage provider processor 1224 of the integrated mileage processing unit 1 220 transmits the personal ID information and the payment information to the corresponding mileage provider server in step S1330. When the personal ID information is not looked up in the member DB 1230 or the member store ID information is not looked up in the integrate mileage DB 1240, the integrated mileage processing unit 1220 informs the corresponding member store that mileage points cannot be accumulated in step S1340.

When receiving the personal ID information and the payment information as described above, the mileage provider server confirms mileage information of the customer that requests to accumulate mileage points, based on the received personal ID information, calculates mileage points corresponding to a payment amount based on the payment information, and adds the calculated mileage points to a current mileage balance of the customer. Also, the mileage provider server transmits a result of accumulation of mileage points to the member store terminal, so that the member can get a receipt for the result of accumulation of mileage points at the member store.

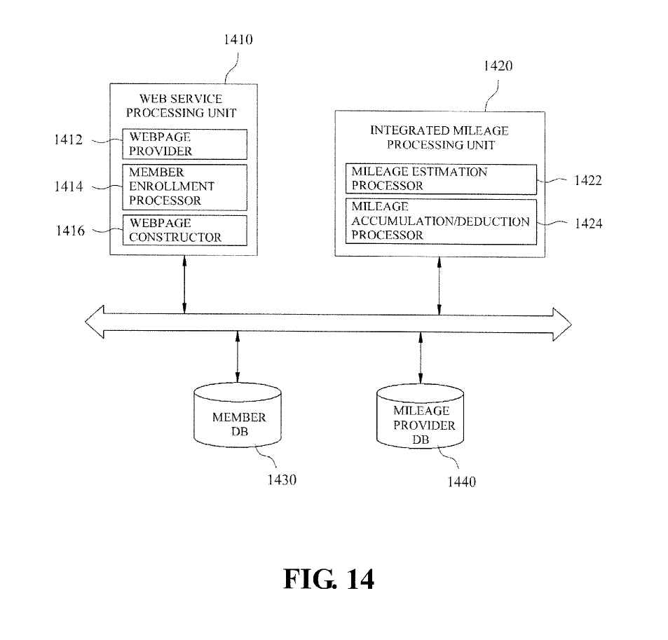

FIG. 14 is a block diagram showing the construction of an integrated mileage server of a system for supplying an integrated mileage service according to yet another exemplary embodiment of the present invention.

Referring to FIG. 14, the integrated mileage server includes a web service processing unit 1410, and a mileage integration processing unit 1420, a member DB 1430, and an integrated mileage DB 1440.

The web service processing unit 1410 includes a webpage provider 1412, a member processor 1414, and a webpage constructor 1416. The webpage provider 1412 receives person related information including personal ID information from individuals via member terminals. The webpage provider 1412 provides first and second webpages to the member terminals. Specifically, the first webpage is set such that an individual can apply for an integrated mileage service in an affiliated, offline enterprise. Also, the second webpage provides mileage information that is matched with at least one offline enterprise used by a member in response to the member's inquiry about mileage information using the member terminal. The webpage provider 1412 also provides a third webpage to an enterprise member terminal when an offline enterprise that applies for a mileage management agency service asks an inquiry about business information of the offline enterprise via a network. The third webpage includes the business information of the corresponding enterprise based on enterprise ID information. The member processor 1414 registers member enrollment information of the member or enterprise required to apply for the corresponding service and processes the registered information. The webpage constructor 1416 loads the corresponding information from DBs in response to an inquiry of the member or enterprise and constructs webpages based on the loaded information.

The mileage integration processing unit 1420 receives payment information including enterprise ID information and member ID information via the enterprise member terminal, searches the member DB 1430 and the integrated mileage DB 1440 based on the member ID information and the enterprise ID information, and determines if the enterprise is an affiliated enterprise and if the individual is a member of the affiliated enterprise. Thus, when it is determined that the enterprise is affiliated and the individual is the member, the mileage integration processing unit 1420 estimates mileage information based on a mileage policy of the corresponding enterprise and the payment information of the member, matches the mileage information with the corresponding enterprise ID information and member ID information, and accumulates or deducts mileage points.

Person related information including personal information that is provided via the set webpage to get the mileage service in the affiliated enterprise is registered in the member DB 1430. Here, the personal information includes a name, a present address, a telephone number, an age, a resident registration number, and a portable phone number of a member, and the member may be requested to necessarily input the resident registration number or the portable phone number since the resident registration number or the portable phone number may be used as member ID information. Meanwhile, an integrated mileage card may be issued as the personal ID information to the member so that the member can present the integrated mileage card in the affiliated enterprise, and information on the integrated mileage card may be matched with member ID information and further registered. Also, log-in related information of an enterprise member is further registered in the member DB 1430 to allow the enterprise member to make access to web information of the affiliated enterprise.

Enterprise related information including enterprise ID information and mileage policy information of each enterprise is registered in the integrated mileage DB 1440. The enterprise ID information is given for identification to at least one affiliated enterprise that has joined the mileage agency service or selected for identification among the enterprise related information. Further, member ID information and member payment information are selected from business information of the enterprise, matched with enterprise ID information, and further registered in the integrated mileage DB 1440.

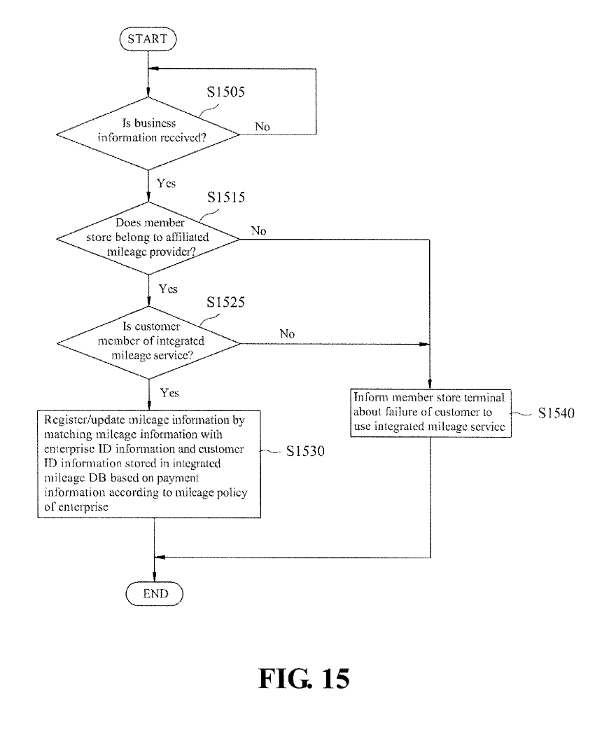

FIG. 15 is a flowchart illustrating a method for supplying an integrated mileage service using the integrated mileage server shown in FIG. 14, according to an exemplary embodiment of the present invention.

When paying for goods or a service in an enterprise, a member of a mileage service agency may inform the enterprise about member ID information and request to accumulate or use mileage points. In this case, a resident registration number or a portable phone number may be presented as personal ID information. Alternatively, the card number of a credit card or another mileage card that is previously registered in the system and carried by the customer may be used as the personal ID information. In response to the customer's request, the enterprise transmits the member ID information and payment information including enterprise ID information via an enterprise terminal to the system. When the system receives the member ID information and business information including the payment information in step S1505, the mileage integration processing unit 1420 searches the integrated mileage DB 1440 based on the enterprise ID information and determines if the enterprise is affiliated in step S1515. When the enterprise is affiliated, the mileage integration processing unit 1420 determines if the member is enrolled as a member in the affiliated enterprise based on the member ID information in step S1525. When the member ID information is matched with the enterprise ID information and looked up, the mileage integration processing unit 1420 transmits the payment information of the member to a mileage estimation processor 1422. The mileage estimation processor 1422 applies the payment information of the member to a mileage policy of the corresponding enterprise and estimates mileage points. For example, when the enterprise employs a policy of mileage per visit, a predetermined number of mileage points are estimated per payment information. Also, when the enterprise adopts a policy of mileage per payment, a predetermined number of mileage points are estimated according to a payment amount. Thereafter, the mileage estimation processor 1422 transmits the mileage information, which is estimated according to the member's payment information, to a mileage accumulation/deduction processor 1424. The mileage accumulation/deduction processor 1424 matches the received mileage information with the corresponding enterprise ID information and member ID information, which is registered in the integrated mileage DB 1440, and accumulates or deducts the corresponding mileage points in step S1530. When the received enterprise ID information is not registered in the integrated mileage DB 1440, when the member has invalid member ID information, or when the member is recorded as a bad user in the member DB 1430 or unregistered in the member DB 1430, the mileage integration processing unit 1420 informs the corresponding enterprise terminal that mileage points cannot be accumulated in step S1540.

Thereafter, the mileage integration processing unit 1420 matches the payment information of the member with the member ID information of the corresponding enterprise, and transmits a result of accumulation of mileage points or a result of deduction of mileage points to the enterprise terminal, so that the member can get a receipt for the accumulation or use of mileage points in the enterprise.

As explained thus far, the system and method for supplying the integrated mileage service has the following effects.

First, a customer can accumulate or spend mileage points at member stores of a plurality of mileage providers by use of a single integrated mileage card so that the customer does not have to carry many mileage cards. Also, itemized statements of accumulation and use of mileage points and a current mileage balance can be managed in one place, and thus it becomes easier to keep track of mileage points. Thus, mileage points corresponding to ten billions of dollars, which are extinguished every year, may be recognized as another property and increasingly utilized.

Second, the customer does not have to connect to a plurality of mileage providers one by one and confirm information on accumulation or use of mileage points for amounts paid at a plurality of member stores. Instead, the customer can integratedly make access to and manage mileage information in one place. More conveniently, the customer can be weekly or monthly informed of accumulated/used mileage points and a current mileage balance at a customer terminal via an e-mail.

Third, a mileage provider can reduce expenses incurred by issuing and managing mileage cards and all marketing expenses. Also, since customers can easily accumulate mileage points and get discounts, brand loyalty and repurchase rate can be improved to cause an increase in sales.

Fourth, the mileage provider allows the customers to access mileage information and confirm a current mileage balance at any time, so that the customers may continuously recognize the mileage points of the mileage provider. Thus, it is possible to arouse the interest of even customers that do not frequently accumulate or use mileage points, so that more customers can be ensured and sales can be increased in the long run.

Fifth, since a member can use accumulated mileage points even at a member store affiliated with a mileage provider that the member have not joined, the member does not have to search for and visit only affiliated member stores.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A system for supplying an integrated mileage service, comprising:
a member store point of sale (POS) terminal for receiving mileage accumulation or spending request data including a card number of an integrated mileage card into which a plurality of membership cards are integrated, a payment amount, and member store identification (ID) information when a customer purchases a commodity;
a mileage provider server for receiving the mileage accumulation or spending request data from the member store POS terminal and accumulating or spending mileage points corresponding to the payment amount based on customer mileage information previously stored in a mileage database (DB) to generate the corresponding result data;
an integrated mileage service server for receiving itemized statements of accumulation or use of mileage points and a current mileage balance of the customer, which are batch-processed at predetermined time intervals, from respective mileage provider servers, storing the itemized statements and the current mileage balance in an integrated mileage DB, and integratedly managing the stored itemized statements and the current mileage balance to provide an integrated mileage inquiry service when a plurality of mileage provider servers are used.

2. A method for supplying an integrated mileage service to gain membership using a system for supplying the integrated mileage service, the method comprising:
connecting to an integrated mileage service server via a customer terminal and gaining membership by selecting a mileage provider, which a customer wants to join as a member, among affiliated mileage providers;
issuing an integrated mileage card having a card number of predetermined digits to a joined member; and
transmitting member information and the card number of the integrated mileage card from the integrated mileage service server to a mileage provider server of the mileage provider selected by the customer with the customer's consent.

3. The method according to claim 2, further comprising:
checking, at the mileage provider server, the card number of the customer's integrated mileage card to confirm if the customer is a member of the corresponding mileage provider;
matching, at the mileage provider server, information on a membership card of the customer with the card number of the customer's integrated mileage card and storing the matched information in a customer database (DB) when the customer is certified as the member of the mileage provider;
enrolling, at the mileage provider server, the customer as a new member and storing personal information of the enrolled customer and the card number of the customer's integrated mileage card in the customer DB when the customer is not certified as the member of the mileage provider.

4. A method for supplying an integrated mileage service to accumulate or use mileage points using a system for supplying the integrated mileage service, the method comprising:
inputting mileage accumulation or spending request data including a card number of an integrated mileage card presented by a customer to purchase a commodity, a payment amount, and member store identification (ID) information via a member store point of sale (POS) terminal;
receiving, at a mileage provider server, the mileage accumulation or spending request data from the member store POS terminal, confirming the card number of the integrated mileage card of the customer that requests to accumulate or use mileage points, and accumulating or deducting mileage points corresponding to the payment amount transmitted via the member store POS terminal to store the total sum of mileage points in a mileage database (DB) of the mileage provider server;
transmitting, at the mileage provider server, an itemized statement of accumulation or use of mileage and a current mileage balance to the member store POS terminal;
transmitting the itemized statement of accumulation or use of mileage and the current mileage balance, which are batch-processed at predetermined time intervals, from respective mileage provider servers to the integrated mileage service server when a plurality of mileage provider servers are used; and
storing, at the integrated mileage service server, the itemized statement of accumulation or use of mileage and the current mileage balance of each of the mileage provider servers in the integrated mileage DB and integratedly managing the stored information to provide the corresponding information stored in the integrated mileage DB to the customer terminal when receiving an inquiry about mileage accumulation from the customer terminal.

5. A method for supplying an integrated mileage service to provide mileage information using a system for supplying the integrated mileage service, the method comprising:
inputting mileage accumulation or spending request data including a card number of an integrated mileage card presented by a customer, a payment amount, and member store identification (ID) information via a member store terminal when the customer purchases a commodity;
receiving, at a mileage provider server, the mileage accumulation or spending request data from the member store terminal, confirming the card number of the integrated mileage card of the customer that requests to accumulate or use mileage points, accumulating or deducting mileage points corresponding to the payment amount, and storing accumulation of mileage points or use of the mileage points in a mileage database (DB) of the mileage provider server;
transmitting information on the accumulation or use of the mileage points from each of mileage providers to the integrated mileage service server when a plurality of mileage provider servers are used; and
storing the information on the accumulation or use of the mileage points of each of the mileage providers in an integrated mileage DB, integratedly managing the stored information as integrated mileage information, and periodically informing a customer terminal about the integrated mileage information via an electronic mail (e-mail).

6. The method according to claim 5, further comprising the customer confirming the accumulation of mileage points or the use of the mileage points via a slip printed by the member store terminal,
wherein the member store terminal is a POS terminal or a credit card terminal.

7. The method according to claim 5, further comprising reading itemized statements of the accumulation or use of the mileage points from the integrated mileage DB and providing the itemized statements to the customer terminal when the integrated mileage service server receives an inquiry about the accumulation or use of the mileage points.

8. A method for supplying an integrated mileage service, comprising:
constructing an integrated mileage database (DB) including member store related information and member information of each of affiliated mileage providers that consent to the integrated mileage service, which is embodied such that mileage points of one affiliated mileage provider are converted into mileage points of another affiliated mileage provider and used;
constructing a member DB including service enrollment information having personal identification (ID) information required for using mileage points of one affiliated mileage provider at member stores of other affiliated mileage providers;
providing a webpage, which is set such that a member selectively requests to convert set mileage points of one of already enrolled mileage providers into integrated mileage points usable at the member stores of other affiliated mileage providers, via a customer terminal of the member;
converting set mileage points of a mileage provider, which has already joined and selected by the member, into the integrated mileage points usable at the member stores of other affiliated mileage providers, based on preset mileage conversion related information in response to the member's request for conversion of mileage points; and
receiving mileage payment information along with member ID information from a member store terminal of a member store belonging to an affiliated mileage provider and deducting previously converted integrated mileage points based on the member ID information.

9. The method according to claim 8, wherein the webpage includes a mileage point inquiry menu of each mileage provider, which is set to selectively confirm the mileage points of the mileage provider that has already joined by the member, the method further comprising receiving mileage point information from the corresponding mileage provider by selecting the inquiry menu, and providing the mileage point information to the customer terminal.

10. The method according to claim 8, wherein converting the set mileage points of the already joined mileage provider into the integrated mileage points comprises:
converting the set mileage points of the mileage provider that has already joined and selected by the member into reference points based on the preset conversion related information; and
registering the reference points by matching the reference points with the member ID information.

11. The method according to claim 8, wherein converting the set mileage points of the already joined mileage provider into the integrated mileage points comprises:
converting the set mileage points of the mileage provider that has already joined and selected by the member into mileage points of another mileage provider, which is selected by the member among the affiliated mileage providers, based on the preset conversion related information; and
registering the mileage points of the selected another mileage provider by matching the mileage points and ID information of the selected another mileage provider with the member ID information.

12. The method according to claim 10, further comprising registering deduction of mileage points used at a member store of the other affiliated member store by matching the deduction result with ID information of each of the already joined mileage provider of which mileages points are converted into integrated mileage points by the member and the other mileage provider used by the member.

13. The method according to claim 10, further comprising informing an operating server of each of the already joined mileage provider of which mileages points are converted into integrated mileage points by the member and the other mileage provider used by the member about deduction of mileage points used at a member store of the other affiliated member store.

14. The method according to claim 11, further comprising registering deduction of mileage points used at a member store of the other affiliated member store by matching the deduction result with ID information of each of the already joined mileage provider of which mileages points are conviction into integrated mileage points by the member and the other mileage provider used by the member.

15. The method according to claim 11, further comprising informing an operating server of each of the already joined mileage provider of which mileages points are converted into integrated mileage by the member and the other mileage provider used by the member about deduction of mileage points used at a member store of the other affiliated member store.
